(19) United States
(12) Patent Application Publication
(10) Pub. No.: US 2016/0332880 A9
(43) Pub. Date: Nov. 17, 2016

(54) FIRE PROTECTION COMPOSITIONS, METHODS, AND ARTICLES

(71) Applicant: Latitude 18, Inc., SIMMS, NC (US)

(72) Inventors: ARUN S. WAGH, NAPERVILLE, IL (US); ANTHONY COLLINS, SIMS, NC (US)

(21) Appl. No.: 14/834,409

(22) Filed: Aug. 24, 2015

Related U.S. Application Data
(63) Continuation of application No. 12/711,077, filed on Feb. 23, 2010, now abandoned.
(60) Provisional application No. 61/285,948, filed on Dec. 11, 2009.
(60) Provisional application No. 61/154,571, filed on Feb. 23, 2009.

(51) Int. Cl. C01B 25/36; C09K 21/04

(52) U.S. Cl. CPC C01B 25/36; C09K 21/04

(57) ABSTRACT

This disclosure relates to inorganic coatings suitable for fire protection, fire retardancy, and articles comprising same. Specifically, the disclosure relates to the manufacture and use of inorganic phosphate-based coating formulations for fire protection, preventing or reducing fire propagation, and for heat management.

### CROSS-REFERENCE TO RELATED APPLICATIONS

The present application claims the benefit of U.S. Provisional Application Nos. 61/154,571 filed on Feb. 23, 2009, and 61/285,948 filed Dec. 11, 2009, the entire contents of each being incorporated by reference herein.

The Government has certain rights in this invention pursuant to Work for Others Agreement WF08504T ANL-IN-______ (DOE S-113,477).

### TECHNICAL FIELD

This disclosure relates to inorganic coatings suitable for fire protection, fire retardancy, and articles comprising same. Specifically, the disclosure relates to the manufacture and use of inorganic phosphate-based coating formulations for fire protection, preventing or reducing fire propagation, and for heat management.

### BACKGROUND

A large number of commercial fire retardant and fire protection products already exist in the market (see, for example, Fire Retardant Materials, by Horrocks and Price, CRC and Woodhead Pub. 429 p, 2007). These commercial products have been developed for fire protection and fire retardancy for architectural coatings and insulation. Many of these commercial products have a number of drawbacks, for example, an inability to bond properly to certain metals like steel and aluminum, the inability of being reusable after exposure to a fire, release of volatile organic compounds (a.k.a. “VOCs”), not functioning properly at very high temperatures, i.e., temperatures higher than about 2000° F., and producing smoke and/or harmful gases.

Commercially available fire retardant coating products exist that can be used on fabric, drapery, wood etc. These products are typically based on compounds containing chlorides, phosphates, borates, etc. In general, these products are designed for reacting with the surface of articles, including polymeric surfaces. These products are also generally acidic and soluble in water or hydroscopic, and hence are susceptible to humid air and water, which can deteriorate their performance over time. Among the commercially available phosphate coatings, most are formed from ammonium polyphosphates, or other phosphorus-based acids including phosphoric acid, which retain their acidic nature after application. These coatings typically require reaction with the substrate at high temperatures, often producing toxic harmful gases. They also produce smoke during combustion, which can be harmful to first responders and others present.

### SUMMARY

Disclosed and described are inorganic phosphate-based fire protection and fire retardant coatings, as well as energy-efficient architectural coatings. In one aspect, the coating comprises essentially an inorganic acid-base phosphate composition applied directly to the surface of an article. In other aspects, the coating comprises additional sub- and top coat-layers.

Thus, in a first embodiment, a method of providing fire protection to an article is provided. The method comprises contacting a surface with a composition comprising (i) an acidic phosphate and fly ash; and (ii) magnesium oxide and phosphoric acid.

In a first aspect of the first embodiment, one or both of the acidic phosphate and the fly ash, and the magnesium oxide and the phosphoric acid, are present, independently or in combination, as an aqueous paste, dispersion, slurry, or emulsion

In a second aspect, alone or in combination with any one of the previous aspects of the first embodiment, the acidic phosphate is mono sodium phosphate, potassium dihydrogen phosphate, or mixtures thereof.

In a third aspect, alone or in combination with any one of the previous aspects of the first embodiment, the fly ash is present in an amount of about 85% by weight of the first layer.

In a fourth aspect, alone or in combination with any one of the previous aspects of the first embodiment, the contacting of the surface with the components of the composition is performed sequentially or concurrently.

In a fifth aspect, alone or in combination with any one of the previous aspects of the first embodiment, the surface is subsequently contacted with a mixture of phosphoric acid, Fe₂O₃ and Fe.

In a sixth aspect, alone or in combination with any one of the previous aspects of the first embodiment, the surface is subsequently contacted with a mixture of phosphoric acid, Fe₂O₃ and Fe₃O₄.

In an seventh aspect, alone or in combination with any one of the previous aspects of the first embodiment, the surface comprises a structural element of a dwelling, steel beams, joists, wall boards, shingles, ceramic tile flooring or counters, brick, stone, a kiln or furnace, a VTOL platform, or a power generator operating under a thermodynamic heat cycle.

In a second embodiment, method of providing fire protection is provided. The method comprises contacting a surface with a composition comprising (i) an acidic phosphate, fly ash, and/or wollastonite or magnesium hydroxide; and (ii) phosphoric acid and at least one compound selected from magnesium oxide, apatite, barite or talc.

In a first aspect of the second embodiment, the fly ash represents about 85% by weight of the composition.

In a second aspect, alone or in combination with any one of the previous aspects of the second embodiment, the magnesium oxide is in the form of periclase.

In a third aspect, alone or in combination with any one of the previous aspects of the second embodiment, the surface is subsequently contacted with a mixture of phosphoric acid, Fe₂O₃ and Fe.

In a fourth aspect, alone or in combination with any one of the previous aspects of the second embodiment, the surface is subsequently contacted with a mixture of phosphoric acid, Fe₂O₃, and Fe₃O₄.

In a fifth aspect, alone or in combination with any one of the previous aspects of the second embodiment, the acidic phosphate is at least one of mono sodium phosphate or potassium dihydrogen phosphate.

In a sixth aspect, alone or in combination with any one of the previous aspects of the second embodiment, the surface comprises a structural element of a dwelling, steel beams, joists, wall boards, shingles, ceramic tile flooring or counters, brick, stone, a kiln or furnace, a VTOL platform, or a power generator operating under a thermodynamic heat cycle.

In a third embodiment, a method of heat management for an article is provided. The method comprises providing an article having a surface, and optionally, contacting the surface of the article with a primer layer adapted to bind to the surface of the article. Contacting the surface of the article or the optional primer layer with an acid-base phosphate layer, wherein the acid-base phosphate ceramic layer further comprises a thermal reflective material or a thermal insulative material, or alternatively, contacting the acid-base phosphate layer with a thermal reflective layer or a thermal insulative layer.

In a first aspect of the third embodiment, the inorganic acid component is at least one of phosphoric acid, magnesium dihydrogen phosphate, potassium dihydrogen phosphate, or aluminum trihydrogen phosphate.

In a second aspect, alone or in combination with any one of the previous aspects of the third embodiment, the acid-base phosphate layer comprises an amount of volatile, non-toxic, bound molecules selected from bound water molecules, carbonates, sulfates, or nitrates.

In a third aspect, alone or in combination with any one of the previous aspects of the third embodiment, the acid-base phosphate layer comprises the combination of (a) at least one of fly ash or magnesium hydroxide; and (b) at least one of phosphoric acid solution, magnesium dihydrogen phosphate, potassium dihydrogen phosphate, aluminum trihydrogen phosphate, or an inorganic acid phosphate solution with a pH lower than 7.

In a fourth aspect, alone or in combination with any one of the previous aspects alone or in combination with any one of the previous aspects of the third embodiment, the wt. % of fly ash or magnesium hydroxide content is between about 70 and about 90.

In a fifth aspect, alone or in combination with any one of the previous aspects of the third embodiment, the wt. % of the inorganic phosphate is about 20.

In a sixth aspect, alone or in combination with any one of the previous aspects of the third embodiment, the primer layer comprises the combination of (a) an iron (III) oxide; (b) a elemental reductant or FeO, and (c) an inorganic acid component.

In a seventh aspect, alone or in combination with any one of the previous aspects of the third embodiment, the primer layer comprises the combination of Fe₃O₄, and phosphoric acid.

In an eight aspect, alone or in combination with any one of the previous aspects of the third embodiment, the elemental reductant is iron.

In a ninth aspect, alone or in combination with any one of the previous aspects of the third embodiment, the thermal reflective material or the thermal reflective layer comprises at least one of synthetic calcined magnesium oxide having periclase phase, powdered aluminum, powdered titania, titanium dioxide, zincite, feldspar or quartz, optionally in an inorganic phosphate binder.

In a tenth aspect, alone or in combination with any one of the previous aspects of the third embodiment, the thermal insulative layer comprises at least one of hematite, cassiterite, magnetite, tourmaline, cummingtonite, fayalite or ash.

In an eleventh aspect, alone or in combination with any one of the previous aspects of the third embodiment, at least one of the compounds in the thermal reflective layer or the thermal insulative layer is combined with the inorganic acid phosphate layer. In one aspect, the zincite or the periclase is combined with the inorganic acid phosphate. In another aspect, the zincite or the periclase is present up to about 90% by weight.

In a twelfth aspect, alone or in combination with any one of the previous aspects of the third embodiment, the coating comprises about 80-90 wt. % of periclase and about 10-20 wt. % of at least one of mono potassium phosphate, magnesium dihydrogen phosphate, aluminum dihydrogen phosphate, or mono sodium phosphate, such that the coating provides an effective amount of infra red radiation reflectivity to the surface.

In a thirteenth aspect, alone or in combination with any one of the previous aspects of the third embodiment, the thermal insulative layer comprises at least one of saw dust, wood chips, or cellulosic materials. In one aspect, the wt. % of the cellulosic material between about 30 to about 40.

In a fourteenth aspect, alone or in combination with any one of the previous aspects of the third embodiment, the surface comprises a structural element of a dwelling, steel beams, joists, wall boards, shingles, ceramic tile flooring or counters, brick, stone, a kiln or furnace, a VTOL platform, or a power generator operating under a thermodynamic heat cycle.

Alone or in combination with any of the aspects of the first, second, or third embodiments, contacting is by spray-coating, brushing, toweling, and/or dipping.

In a fourth embodiment, an article is provide comprising a coating consisting essentially the combination of (a) at least one of fly ash or magnesium hydroxide; and (b) at least one of phosphoric acid solution, magnesium dihydrogen phosphate, potassium dihydrogen phosphate, aluminum dihydrogen phosphate or an inorganic acid phosphate solution with a pH lower than 7.

In a first aspect of the fourth embodiment, the article comprises a oil well bore hole casing stabilizing element, or a repairing and zonal isolating article adapted for wells, the casing stabilizing element and repairing and zonal isolating articles preventing or reducing fire propagation.

In a fifth embodiment, an article is provided comprising a coating consisting essentially of an acidic phosphate, fly ash, magnesium oxide and phosphoric acid.

In a sixth embodiment, an article is provided comprising a coating consisting essentially of the combination of an acidic phosphate, magnesium hydroxide, phosphoric acid and at least one compound selected from magnesium oxide, apatite, wollastonite, barite, or talc.

In a seventh embodiment, a method of producing a high-temperature resistant coating comprising berlinite is provided. The method comprises: providing a first component comprising at least one of phosphoric acid or aluminum trihydrogen phosphate AlH₃(PO₄)₂ or its hydrates; providing a second component comprising at least one of aluminum hydroxide or aluminum oxide; combining the first component and the second component together; and contacting a surface of an article with the combination of the first component and the second component; heating the surface of the article at an elevated temperature sufficient to form a coating comprising a berlinite phase (AlPO₄) detectable by x-ray diffraction.

Alone or in combination with any of the aspects of the first, second, third, fourth, fifth, sixth, or seventh embodiments, the phosphate composition or its acidic/alkaline components are provided as a paste, slurry, suspension, emulsion, or gel.

This disclosure embodies formulations and architecture materials and, in certain aspects, the sequence in which these coatings are applied. The one or more coatings comprising the fire protection and heat management layer of the article can, independently, applied in many ways, including spraying; troweling, dipping, and brushing. In one aspect, application of the inorganic phosphate based formulation (e.g., paste, slurry, suspension, emulsion, gel, or the like) can be activated by a suitable activator prior to application.

While several systems and methods are contemplated by the various aspects disclosed and described, set forth below are exemplary coatings, for example, single-layer and multi-layer coatings, as a way of illustrating some of the disclosed aspects. It is understood that other single layer or multiple-layer coatings are also contemplated that use the same compositions, as well as different numbers of layers and the same or different compositions for each layer.

### BRIEF DESCRIPTION OF THE DRAWINGS

FIG. 1A is an illustration of a mono-layer fire protection coating disclosed and described herein.

FIG. 1B is an illustration of a multi-layer fire protection coating disclosed and described herein.

FIG. 1C is an illustration of a multi-layer fire protection coating with thermal reflective topcoat as disclosed and described herein.

FIG. 1D is an illustration of a multi-layer fire protection coating with thermal insulative topcoat as disclosed and described herein.

FIG. 2 is a graphical representation of data obtained from fire protection coatings as disclosed and described.

### DETAILED DESCRIPTION

Coatings for fire protection and heat management comprising inorganic phosphate ceramic compositions suitable for articles are disclosed and described. These compositions are useful as surface coatings on surfaces such as wood, steel, aluminum, titanium, metal alloys, and other non-polymeric surfaces. Inorganic phosphate-based formulations are disclosed that can be used as coatings to prevent or retard combustion of the article, prevent or retard fire spread of the article, as well as to provide thermal management to the article. The compositions disclosed and described herein are produced by combining an acidic inorganic phosphate component with an inorganic basic component (acid-base reactions), to provide essentially a neutral, ceramic/refractory-like coating which is well adhered to the surface and stable at very high temperatures, i.e., higher than about 2000° F. These coatings are superior to most of the commercial products with regard to their stability and heat management performance at sustained high temperatures. Additionally, the coating compositions, methods, and articles made therefrom as disclosed and described herein exhibit advantages that are not typically found in other coatings and articles coated therewith, such as durability after a first fire event, superior thermal protection performance, and no release of toxic fumes during fire.

The coating system disclosed and described herein are useful as inorganic architectural coatings for dwellings. As used here, the phrase “architectural coatings” is intended to encompass improved paint or sealant compositions/coatings, and include combinations with coatings formulations not normally used for fire protection or fire retardancy. For example, the acidic inorganic phosphate component and/or alkaline component can be used in combination with conventional paint to impart aesthetic and maintenance (e.g., color and texture) in addition to fire protection and heat management. While most commercially sold paints are polymer-based, with small amounts of inorganic minerals present as fillers, such as wollastonite, titanium dioxide, and pigments, these products are essentially absent an inorganic phosphate ceramic, are VOC intensive, produce significant amount of green house gases during their production, and more importantly, are themselves flammable. In contrast, the phosphate coatings disclosed here are predominately inorganic and/or ceramic in nature, do not produce VOCs, produce only as little as about 20% of green house gases compared to polymeric paints, are durable, are not deteriorated by ultra violet radiation, and are reflective to infra red radiation. Thus, the herein disclosed inorganic phosphate coatings support energy conservation in a variety of construction aspects.

The inorganic phosphate coatings disclosed and described herein are exclusive of conventional Portland cement based fire protection coatings. In contrast to that of Portland cement, the inorganic phosphate coatings disclosed and described herein are neutral in pH and two-to-three times the strength. The inorganic phosphate coatings disclosed and described herein set faster than Portland cements and their carbon foot print is only one fourth that of Portland cement.

The inorganic phosphate coatings disclosed and described herein are useful as fire protection coatings covering a wide range of temperatures, including higher than about 2000° F. In some aspects, the inorganic phosphate coatings disclosed and described herein are useful as fire protection coatings, e.g., between about 2000° F. and about 4000° F., or higher. Thus, the inorganic phosphate coatings disclosed and described herein are useful as insulation coatings on energy generators and high temperature kilns, and also as coatings on launching pads/platforms for vertical take off and landing aircrafts (“VTOL pads”), coatings on vehicles in hot desert-like or extraterrestrial environments. The inorganic phosphate coatings disclosed and described herein are also useful in applications where incident infra red radiation needs to be reflected and the article needs to be thermally insulated.

The herein disclosed and described inorganic phosphate coatings need minimal or no surface treatment in order to apply them to the surface of an article. It has been found that the disclosed inorganic phosphate coatings bond well to metals, alloys, and to wood, as well as to many other non-polymeric surfaces; therefore the overall cost of their use is significantly lower than comparative coatings requiring priming layers, for example. Notwithstanding the above, in certain aspects, a primer layer can be advantageously used if desired, or for providing other functionality to the article.

In a preferred aspect, the inorganic coatings disclosed herein are applied directly to the surface of an article, with essentially no pre-treatment of the surface or use of a priming layer. In this particular aspect, the acidic phosphate component preferably is at a pH of about 0 to about 5, optionally in combination with fly ash. While not being held to any particular theory, it is believed that such formulations are most suitable for steel coatings because the acidic component forms its own primer on steel resulting from the reaction with steel, and helps bond the product formed by the acid base reaction. This resultant phosphate coating acts as an insulating layer to heat, protects the substrate from direct contact with fire, and also helps in reducing heat impact by reflecting infra red radiation and by evaporating in situ bound water, thus cooling the surface, thereby reducing the heat impact.

The formulations and the coating architectures disclosed and described herein are useful for the following applications, without limitation. Other applications, or use in combination with other coatings, are also contemplated.

There exist a range of commercial products that have been developed for fire protection. For illustration of the benefits and advantages of the instantly disclosed phosphate coatings, these commercially available coatings (collectively referred to as “comparative coatings”) are categorized below, and contrasted with the presently disclosed and described phosphate coatings:

Polymer based intumescent coatings: Epoxy based intumescent coats are applied in thin layers to protect structural elements. By definition, at elevated temperatures, intumescent coatings expand, become insulating and protect the substrate associated therewith from softening. Before applying intumescents, the substrate, e.g. steel needs a pretreatment, and/or a wire mesh is typically used for anchoring the intumescent coating to the article. Pitt Char of PPG Industries and Chartek of International Protective Coatings are some examples of intumescent coatings. Neither of these coatings contains phosphate ceramics.

Cement based coatings: Portland cement based coatings are used both as intumescent and cellulosic fire retardant coatings. The low thermal conductivity of cement (0.29 Watt/meter-Kelvin), and with the addition of gypsum (CaSO₄.2H₂O) and mica, these cement products provide at least one hour of protection at typical flame temperatures. Pyrocrete is an example of a cement based coating. Cement based coatings also need a primer layer, typically to protect steel from corrosion, and typically require a wire mesh wrapping to hold the cementatious coating about the article.

The comparative fire protection coatings described under (a) and (b) above have the following drawbacks: (i) they do not bond effectively to wood, steel, aluminum, or other metals and alloys commonly used structural elements. These comparative coatings require extensive preparation of a metal surface, and also need wire mesh wrapping to anchor to the coatings. Likewise, cementatious coatings also require preparation of the surface and use of wire mesh anchors, etc., which raises the application cost significantly. In contrast, the instant phosphate coatings disclosed and described herein do not require preparation of the surface of the article or require any anchoring mechanisms.

(ii) The comparative coatings described above survive only one fire event. While they may provide the required protection, they are sacrificed in the process. In contrast, the instant phosphate coatings disclosed and described herein are essentially intact after exposure to heat and flame and thus may be useful thereafter for continued fire protection.

(iii) Several of the intumescent comparative coatings release volatile organic compounds (VOC's) during combustion or upon exposure to elevated temperatures consistent with fire. In contrast, the instantly disclosed phosphate coatings are essentially composed of inorganic materials and thus, do not release VOCs.

(iv) Most of the comparative coatings are not generally useful at temperatures higher than about 2000° F. Many of the phosphate coatings disclosed and described herein can be used at temperatures higher than about 2000° F., including temperatures up to 4000° F.

Some of the inorganic phosphate coatings disclosed and described herein are stable at very high temperatures. In particular, the instantly disclosed magnesium- and aluminum oxide-containing inorganic phosphate coatings are refractory materials that beyond 700° C., can sinter and fuse into stable ceramic coatings. As a result, they can provide for coatings on high-temperature surfaces such as the surfaces of hot power generators, interior of kilns, launching pads of VTOL aircrafts. The instantly disclosed magnesium- and aluminum oxide-containing inorganic phosphate coatings have low thermal conductivity and hence act as thermal barrier coatings. As a result, these magnesium- and aluminum oxide-containing inorganic phosphate coatings provide for improved thermodynamic efficiency of heat engines by increasing the difference between the internal and the external temperatures during operation. Similarly, reduced thermal heat transfer from kilns is provided using the magnesium- and aluminum oxide-containing inorganic phosphate coatings.

### Architectural Coatings:

Most paints sold in the market are polymeric, in which inorganic minerals such as wollastonite are added as fillers, albeit in small wt. % amounts. Moreover, polymers are VOC intensive, produce significant amount of green house gases during their production and combustion, and more importantly, are flammable. In contrast to conventional polymeric paints, the coatings disclosed and described herein are essentially phosphate ceramic in nature and, hence, are chemically durable in any ambient environment. The instantly disclosed inorganic phosphate coatings can be combined with most conventional paint formulations. Preferably, the paint formulation is formulated for spray coating, so that conventional equipment can be used and the acidic and alkaline components of the phosphate ceramic can be kept separate until application. Using the infra-red-radiation-reflective top coat described in detail below, energy conserving paints can be formulated. Thus, the instantly disclosed inorganic phosphate coatings can be used to manufacture energy-efficient shingles, sidings and other external/internal structures and architectural components that are or may be exposed to intense or prolonged heat sources, such as direct sunlight, fire, etc. These coatings are also useful for the heated interiors of a dwelling where internal temperatures can be maintained by reducing the absorption of radiant heat, for example, incident on walls and floors.

The coatings disclosed and described herein are based, at least in part, on optimizing the following three parameters; maximizing enthalpy of dissociation, providing low thermal conductivity and/or providing high radiant thermal reflectivity. The parameters may be adjusted independently from each other as needed for the particular end-use application as disclosed below.

### Maximizing Heat of Dissociation

Phosphate ceramics are formed with significant amount of bound water. During fire, the bound water contained in the phosphate ceramic evaporates, but the structural integrity of coating does not significantly deteriorate. As a result, significant amount of heat energy is consumed in evaporating water and therefore a significant amount of heat does not reach to the substrate metal to be protected. Additionally, the structural integrity of the herein disclosed phosphate ceramic coatings is not substantially affected, unlike Portland cements that are substantially destroyed during fire, thus making the herein disclosed phosphate coatings superior to that of Portland cement coatings for fire protection.

It is also possible to combine or react minerals with high amounts of water of hydration, particularly clay minerals, with the acid phosphate component and form ceramic coatings that will contain significant amount of bound water. In the event of a fire or other source of intense heat, this water will evaporate, consuming some of the heat as enthalpy of evaporation. The clay minerals are also useful as fillers and/or processing/delivery agents for the herein disclosed phosphate coatings in addition to enhancing their heat consumption during fire.

Table 1 provides details of these cements, the percentage of water in them and latent heat consumed during dissociation of water from the matrix, to approximate when fire heats the coating. As comparative examples, the list includes magnesium hydroxide, gypsum, and Portland cement.

TABLE 1
Phases in phosphate, hydroxides, and clays, bound water fraction and latent heat
of evaporation

| | | Bound water | Total of dissociation and |
|---|---|---|---|
| | | fraction | latent heat of |
| Material | Phases | (wt. %) | evaporation (Joules/g) |
| Magnesium hydroxide | Mg(OH)₂ | 30.88 | 1,356 |
| (Mg(OH)₂) | | | |
| 90% (Mg(OH)₂) + 10% | 11% MgKPO₄•6H₂O + 89% Mg(OH)₂ | 32 | >1,335 |
| MKP resin | | | |
| Magnesium potassium | MgKPO₄•6H₂O | 40.5 | >919 |
| phosphate (MKP) | | | |
| Magnesium hydrogen | MgHPO₄•3H₂O | 31 | 1,512 |
| phosphate (Newberyite) | | | (measured) |
| Ash reacted with | | | |
| phosphoric acid | | | |
| 90% ash and 10% MKP | MgKPO₄•6H₂O + complex products | 11 (measured) | 1,890 |
| resin | from ash | | (measured) |
| 85% ash and 15% MKP | MgKPO₄•6H₂O + complex products | 6 | 1,031 |
| resin | from ash | | (estimated) |
| Montmorillonite | (Na,Ca)_{0,3}(Al,Mg)₂Si₄O₁₀(OH)₂•n(H₂O) | 36 | >817 |
| (hydrous aluminum | | | |
| silicate) | | | |
| Portland cement | C3S and C2S phases | 28.6 | 649 |

The total heat absorbed due to dissociation and as latent heat of evaporation indicated in the last column of Table 1 contains many numbers that are minimum of the actual numbers (indicated by the sign “>”before the entries). Actual values will be larger than these because the bond energy of water in the crystalline structure of some of the products is not available and hence the values only estimate the minimum energy related only to latent heat of evaporation of water. As one may notice from Table 1, Mg(OH)₂, and most phosphate ceramics have much higher heat of evaporation compared to gypsum or Portland cement. Therefore, coatings of the herein disclosed phosphate ceramic coatings take much longer to heat the underlying metal structural elements compared to Portland cement or gypsum fire protection coatings.

### Low Thermal Conductivity Materials and Topcoats

In Table 1, though ash composition shows lower water of evaporation (and still higher heat absorption, possibly due to phase changes), ash has very low thermal conductivity between 0.07-0.35 W/mK, with an average 0.1765 W/mK. With the composition disclosed and described herein, ash can be reacted in high proportion with an acid phosphate to form ash cement. The net result is cement with very low thermal conductivity of approximately 0.2 W/m·K. Most of the fire protection coatings are formed with this cement.

It is also possible to use hydroxides that release water upon heating, produce porosity and reduce the thermal conductivity. Magnesium hydroxide (Mg(OH)₂), whose properties are given in Table 1, releases 33% of its weight as water. This generates porosity in the matrix which reduces thermal conductivity in the material. One may also use low-cost clay minerals such as montmorillonite clay, Montmorillonite clay, whose relevant properties are given in Table 1, releases 36% of its weight as water and acts as an insulator. It can be used as filler in the compositions disclosed herein. Similarly, bentonite is another exemplary clay that expands when sets and hence provides low density phosphate product with high insulation.

In addition to ash, hydroxides, and clay minerals, it is also possible to use insulating materials such as saw dust or other natural cellulosic matter. Such materials can be used as fillers in phosphate ceramics and they become non flammable. Their thermal conductivity is very low, ˜0.1 W/m·K, and hence they reduce the thermal conductivity of the overall coating. Low conductivity materials can be added to the inorganic phosphate coating or can be applied over such coatings to provide for improved thermal conductivity of the article.

### Thermal Reflective Materials and Topcoats

The inorganic phosphate coatings disclosed and described herein can be formulated to provide enhanced infra red radiation reflectivity while maintaining good bonding to almost any non-polymeric substrate. Preferably, the inorganic phosphate coatings comprising thermal reflective formulation provide one or more of the following attributes: (1) reduced radiant/conductive thermal transport from the fire to the article surface by consuming incident energy to dissociate and evaporate bound water, providing good insulation; (2) enhanced reflectivity of the coated surface to infra red rays, thereby reducing absorption of the incident energy on the top surface; and (3) good bonding/adhesion between the inorganic coating and almost any non-polymeric substrate. This represents a comprehensive approach to managing overall heat transfer from the incident radiation present during a fire to the article in need of such protection. High radiant thermal reflective materials can be added to the inorganic phosphate coating or can be applied over such coatings to provide for improved thermal reflectivity of the article.

Combining the inorganic phosphate ceramic coating with materials of high reflectivity to infra red radiation provides for reflection of at least part of the infra red radiation present during a fire and thus, avoids its thermal transfer through the coating. Table 2, below, shows the reflectivity of suitable materials used in the inorganic phosphate coatings described herein. Table 3 shows the minerals of high reflectivity that can be used in the inorganic phosphate coatings described herein. The reflectivity of most materials, with the exception of ash, is very high and, hence, when used in combination with the inorganic phosphate coatings disclosed herein provide superior high reflectance of incident radiation.

TABLE 2
Reflectivity of matrix materials

| | | Particle | |
|---|---|---|---|
| Mineral | Chemical formula | size (μm) | Reflectivity |
| Periclase | MgO (Matrix component) | <45 | >0.9 |
| Corundum | Al₂O₃ (matrix component) | <500 | 0.65-0.95 |
| Apatite | Ca₅(PO₄)₃F | <45 | 0.7-0.8 |
| Anhydrite | CaSO₄ | <45 | 0.9-0.93 |
| Wollastonite | CaSiO₃ | <45 | 0.8 |
| Talc | MgSiO₃ | <45 | 0.85 |
| Ash | Mainly Al₂O₃, SiO₂, CaO | | 0.2-0.3 |

One may use additional materials for the top coat in order to enhance the reflectivity of the fire protection coatings disclosed herein. These materials include apatite (calcium phosphate), talc (magnesium silicate) and metal powders, specifically aluminum, which reflects most infrared radiation and hence reduces heat transfer to the substrate material during a fire or under intense heat operation.

TABLE 3
High reflectivity materials

| | | Particle | |
|---|---|---|---|
| | | size | |
| Mineral | Chemical formula | (μm) | Reflectivity |
| Anatase | TiO₂ | <45 | >0.9 |
| Zincite | ZnO | <45 | >0.9 |
| Celestite | SrO₄ | 45-125 | >0.9 |
| Quartz | SiO₂ | <500 | 0.8 |
| (crystal) | | | |
| Feldspar | (K_{0.69}Na_{0.29}Ca_{0.01})Si_{2.99}Al_{1.01}O₈ | <125 | 0.8-0.85 |
| (orthoclase) | | | |
| Metals | Aluminum | | 0.98 |

### Thermal Insulative Materials and Topcoats

If the coating is to be used for heat management (e.g., energy conservation) in applications such as insulating covers on heat engines and power generators, it is important to use low-reflectivity coatings. Table 4, below, sets forth a list of minerals useful for the low-reflectivity coatings disclosed and described herein. Other low reflectivity or insulative materials may be used or combined with the materials of Table 4 in combination with the inorganic phosphate coatings disclosed herein.

TABLE 4
Low reflectivity materials

| | | Particle size | |
|---|---|---|---|
| Mineral | Chemical composition | (μm) | Reflectivity |
| Hematite | Fe₂O₃ | 45-500 | <0.1 |
| Cassiterite | SnO₂ | 45-500 | 0.05 |
| Magnetite | Fe₃O₄ | <500 | <0.1 |
| Tourmaline | Na(Mg₃Fe₃²⁺)Al₆(BO₃)₃ | 125-500 | <0.08 |
| Cummingtonite | (Mg,Fe³⁺)Si₈O₂₂(OH)₂ | 125-500 | <0.1 |
| Fayalite | (Fe_{1.89}Mn_{0.08}Ca_{0.03}) SiO₄ | 125-500 | <0.1 |
| Ash | Mainly Al₂O₃, SiO₂, CaO | | 0.2-0.3 |

Methods of Coating Articles with Inorganic Phosphates

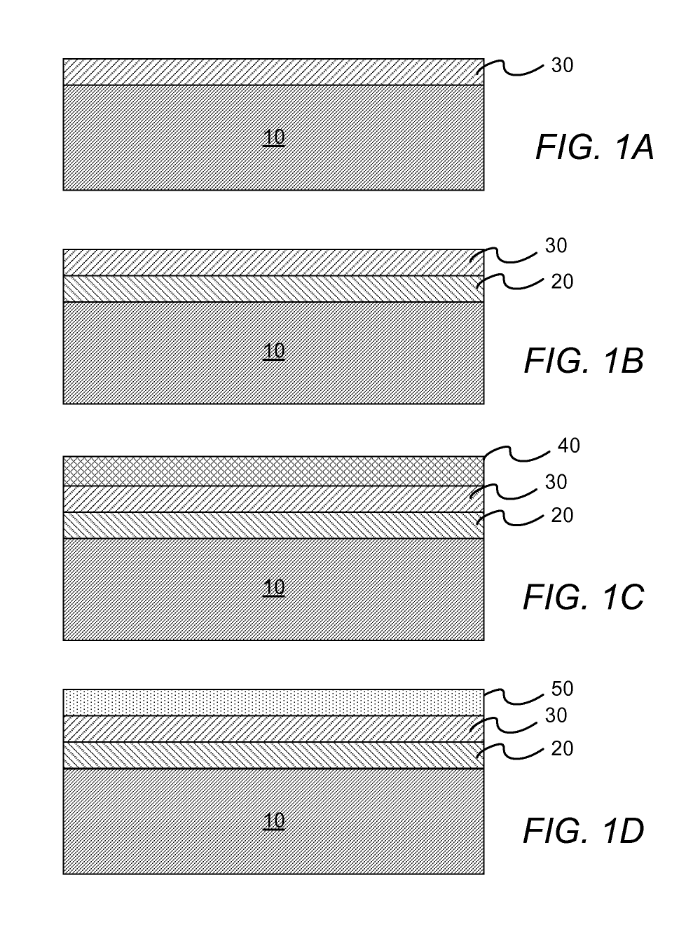

Inorganic phosphate coatings described above can be applied in one of four aspects. Other coating sequences may be used. With reference to FIG. 1A, in the first aspect, a single layer consisting essentially of an inorganic phosphate coating (20) comprising an acidic inorganic phosphate component and an inorganic alkaline component are contacted with the surface of article (10). Article (10) need not be heated or otherwise pretreated (e.g., polished, sanded, etc.) prior to contacting with coating (20), however, such treatments can be used if desired.

With reference to FIG. 1B, in the second aspect, a multi-layer architecture of primer layer (30) contacting the surface of article (10) and inorganic phosphate coating (20) comprising an acidic inorganic phosphate component and an inorganic alkaline component contacting the primer layer (30) is depicted. The primer layer provides improved bonding between the surface of the article and the second layer. The primer layer can be modified in accordance with the substrate. For example, magnesium-based phosphate coatings generally do not bond well to steel and polymers, but bond to aluminum, wood, and other materials. Therefore, for example, a primer based on iron phosphate, which bonds to steel can be employed for magnesium-based phosphate coatings. Thus, C iron phosphate is used as the primer in the magnesium-based phosphate coating design when the substrate surface is steel. The primer layer can be between about a few angstroms to about 5 micrometers thick. The phosphate coating is generally thicker than the primer layer. Depending on the protection time needed for the article (e.g., to postpone heating of the inner portions of the article to 1000° F.), the thickness of the coating can be varied. In some aspects, an effective coating thickness of inorganic phosphate is about half an inch to about one inch thick layer can be used.

With reference to FIG. 1C, in the third aspect, a multi-layer architecture of primer layer (30) contacting the surface of article (10), inorganic phosphate coating (20) comprising an acidic inorganic phosphate component and an inorganic alkaline component contacting the primer layer (30), and a low thermal conductive layer (40) is depicted. As discussed above, the inorganic phosphate coating is designed to consume as much heat as possible by evaporating bound water or decomposing the mineral components into a solid and a gaseous phase, such as carbon dioxide from carbonates. As discussed above, phosphate compositions retain significant amount of bound water. This water is removed from the crystal structure and it evaporates and consumes much of the incident energy as energy of dissociation and latent heat of evaporation. Another function of the phosphate coatings includes reducing thermal transport from the outer hot environment to the substrate. Low thermal conductivity materials can be added to the phosphate coating layer to increase the amount of water retained or may be provided as a separate topcoat (40). For example, these low conductivity materials can also be combined or reacted with the phosphate layer (20) for example, simultaneously or sequentially upon deposition to the article surface. It is generally believed that when the bound water is removed during extreme heat exposure, porosity is generated within the phosphate coating and/or topcoat, reducing the thermal conductivity of the coat at least by the second power of the ratio of the final density to initial density. Thus, removal of water from the phosphate coating and/or the topcoat provides for a reduction of thermal transfer from the surrounding environment to the bulk of the article.

With reference to FIG. 1D, in the fourth aspect, a multi-layer architecture of primer layer (30) contacting the surface of article (10), inorganic phosphate coating (20) comprising an acidic inorganic phosphate component and an inorganic alkaline component contacting the primer layer (30) and a thermal reflectivity top coat contacting the phosphate layer (20). A range of minerals can be used for providing the thermal reflectivity topcoat. The thermal refractivity materials can also be combined or reacted with the phosphate layer (20) for example, simultaneously or sequentially upon deposition to the article surface. Suitable thermal reflectivity topcoats comprise oxides, for example, magnesium oxide in periclase form apatite, barite and talc. Apatite (calcium phosphate) and talc (magnesium silicate) can be easily combined or reacted with the phosphate layer to provide a topcoat. The use of all three coatings will depend on the performance requirements and/or cost. Any one of the four aspects discussed above can be used independently, particularly for architectural coatings.

### Experimental Section

The following examples are illustrative of the embodiments presently disclosed, and are not to be interpreted as limiting or restrictive. All numbers expressing quantities of ingredients, reaction conditions, and so forth used herein may be to be understood as being modified in all instances by the term “about.” Accordingly, unless indicated to the contrary, the numerical parameters set forth herein may be approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

### EXAMPLE 1

### Flame Spread Test

Douglas fir plywood of thickness of quarter inch was coated with paste produced by adding 10% dead burnt magnesium oxide, 30% mono potassium phosphate, and 60% Class C fly ash and water. The amount of water added to this mixture to produce paste was about 20% of the total powder weight. We also added 2% boric acid and mixed the entire mixture in a table top mixer. In about 20 minutes, a smooth thin paste was provided that was applied on the plywood at a thickness of about one-eighth of an inch. The coating set into a hard layer in approximately one hour.

The sample was cured for three weeks and was subjected to ASTM 84 (same as UL 723) test. The sample was mounted at an angle leaning towards opening of a furnace. Direct radiant heat was incident on the sample. The sample was divided into five horizontal zones as per the procedure. The center of the top zone was in direct contact with a small flame to ignite the sample. Depending on the zone to which the flame spreads, rating of performance is determined. Douglas fir without any coating started burning immediately and the flame spread quickly to the bottom of the sample. In contrast, the coated sample of Example 1 was not affected by the flame after 20 minutes, except some charring at the point where the flame was in contact with the sample. A small blue flame appeared at that point but it did not spread. When the external flame was removed, the blue flame extinguished itself. Thus, the coated sample passed flame spread with a rating of “A”.

### EXAMPLE 2

### Cellulosic Fire Protection Tests

Mild steel plates of dimensions 3×3×0.5 inch were used for this study. A thermocouple was inserted through a hole to the center of each plate. Each of these plates was primed with iron phosphate to ensure that the second coat will bond to the plate. The iron phosphate coating was a mixture of phosphoric acid and magnetite (Fe₃O₄). This coating had a thickness of less than 0.125 inch. Once this primer had set in for one day, the actual fire protection coating was applied. The compositions of these coatings are presented in Table 5. In each case, powders were mixed with water for 20 minutes, or until the temperature of the paste rose to 85° F., and then the paste was spray-coated on the steel sample.

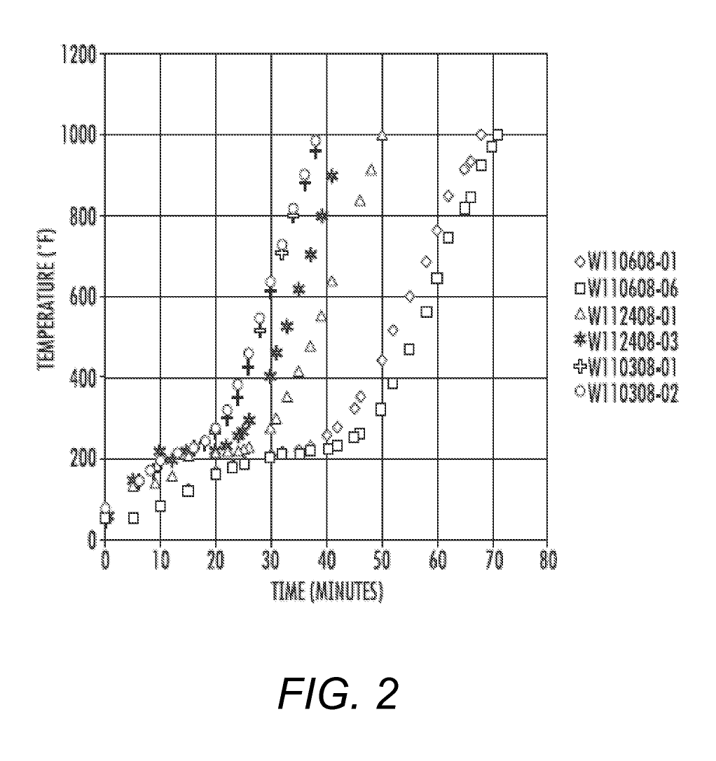

Samples with half-inch thick and one-inch thick coating all around the steel plate were prepared. The samples were cured for at least one week. Then, a coating comprising a mixture of magnesium dihydrogen phosphate (“MHP”) prepared from 300 grams on magnesium dihydrogen phosphate dissolved in 200 grams of water. The slurry was stirred continuously until a saturated solution had formed. Some phosphate remained undissolved in the water and the pH of the solution was 4.2. The paste was of a thin consistency when a mixture of 100 grams of magnesium oxide and 600 grams of Class C fly ash was added. A thick paste formed after mixing for about 20 minutes that could be sprayed with a spray gun. This composition was applied to the sample to produce a thin white coat that enhanced infrared reflectance of the surface. These samples were introduced into a furnace capable of reaching at least 2000° F. The thermo couples were connected to a Fluke Hydra data logger and furnace. The furnace was fired at a rate given in ASTM 84 procedure and the temperature read by the thermocouple was monitored. As per the Standard, the fail time was defined as the time needed for the plate temperature to reach 1000° F. Results are given in the last column of Table 2, and the profile of the rise in temperature for each sample is given in FIG. 2.

As shown in Table 2 and FIG. 2, the fail time for one-inch thick coatings (indicated by symbols (▪) and (♦)) was 68 and 71 minutes, while for half-inch thick coatings (indicated by symbols () and (*)), the fail time was 39 minutes. For comparison, commercially available coatings, such as Pitt Char, provide about 40 minutes or less of protection before failing, demonstrating that the one-inch thick coating of Example 2 performed equal to or better than several commercially available materials currently in use.

TABLE 5
Composition and test results

| | Composition (wt. %) of total powders | | | | | | | |
|---|---|---|---|---|---|---|---|---|
| | | | Fly | | | | Thickness | Fail time |
| Sample no. | MgO | MKP | ash | Cenospheres | B. acid | Water | (inch) | (minutes) |
| W110608-01 | 10 | 30 | 60 | 0 | 0.17 | 20 | 1 | 68.28 |
| W110608-06 | 7 | 21 | | 72 | 0.1 | 16 | 1 | 71.07 |
| W110308-01 | 10 | 30 | 60 | 0 | 0.17 | 20 | 0.5 | 39.17 |
| W110308-03 | 10 | 30 | 0 | 60 | 0.19 | | 0.5 | 39.17 |

Several inferences may be drawn from the profiles in FIG. 2. Each curve rises slowly initially at lower temperatures, and then has a flat trough at the center before it rises again more rapidly. It is generally believed that the initial slow rise may be attributed to a lower outside temperature. The flat region starts at approximately 200° F., where the temperature is held constant for almost 20 minutes in samples with one-inch thickness. For the coating compositions used in producing these samples, the amount of water added, which ends up in the sample as bound water, is about 20% of the total coating weight. As discussed herein and calculated in Table 1, the amount of bound water will consume as much as 919 joules per gram of the material by evaporating. Because of this, little if any thermal transport occurs during this period and the temperature of the steel plate does not change significantly. The results also show that there is a marginal advantage gained by replacing fly ash with cenospheres (e.g., hollow silica spheres separated from ash). Thus, ash is an effective, low-cost material that can be used in producing good fire protection coatings of the compositions disclosed and described herein.

### EXAMPLE 3

### Hydrocarbon Fire Retardant Product Test

Hydrocarbon fire retardant test is similar to cellulosic test, with the difference being that the temperature of the furnace is increased at a much rapid rate, reaching 2000° F. in just a few minutes. Sample shapes and sizes used in Example 3 were the same as in Example 2.

Table 6 summarizes the coating compositions used in this Example, which were different from those used in Example 2. Curves represented by symbols (▴) and (+) lines of FIG. 2 are representative of the data obtained for Example 3 samples. The primer was the same and top reflective coating was the same as described in Example 2, however, the bulk coat had essentially no MgO present and was made by mixing either fly ash or cenospheres, both supplied by Boral Cements. Samples were less than one-week old, with top coats applied just before the test.

TABLE 6
Composition and test configurations

| Sample no., | Composition (wt. %) | | | |
|---|---|---|---|---|
| coating | of total powders | | | Fail time |
| thickness | MKP | Fly ash | Cenospheres | (minutes) |
| W112408-01 | 15 | 85 | 0 | 50.28 |
| 1 inch | | | | |
| W124608-01 | 15 | 0 | 85 | 43.38 |
| 1 inch | | | | |

The results show that in this test the fail times of Example 3 samples were 50 and 43 minutes. Pitt Char, an intumescent coating, gives only about 30 minutes in hydrocarbon test, and at the end the material expands and falls apart. In contrast, for the Example 3 samples, a thin top coat layer, peeled off, but the bulk coating remained undisturbed. It is believed that due to the heat, the ash-containing compositions of Example 3 may have hardened further. This demonstrates that the disclosed and described coatings of Example 3 can survive more than one fire incidences, for example, re-paint the top coat for providing additional fire retardancy performance.

### EXAMPLE 4

### Fabrication of Fire Retardant Material from Saw Dust

Zero flame spread composites using phosphate binders such as mono potassium or mono hydrogen phosphate reacted with magnesium oxide and saw dust or similar cellulosic materials as fillers provides flame retardant properties. In one test, we took 33 wt. % untreated saw dust, mixed it with 17 wt. % calcined magnesium oxide and 50 wt. % magnesium dihydrogen phosphate (Mg(H₂PO₄)₂.2H₂O). Water was added to the mixture and mixed quickly to soak the saw dust and dissolve the phosphate. The entire pulp was then pressed in a brick form in a mold at a pressure of 1000 psi. Excess water squeezed out and acid-base chemical reaction occurred which heated the sample significantly. It set within minutes into a hard brick form. This sample was then subjected to intense flame using an oxy-acetylene torch. Wherever the flame touched the sample, small blue flame was observed. However, once the torch was moved away, the flame extinguished itself. There was no smoke and even when the torch flame was touching the sample, there was no flame spread. This result indicates that it is possible to produce products using waste saw dust or any other similar material, bind it with phosphate binders and produce non flammable products.

### EXAMPLE 4

### Zonal Isolation in Oil Wells for Fire Protection

A mixture of about 85 wt. % ash and about 15 wt. % mono potassium phosphate were mixed to provide a powder composition. To this mixture was added water in an amount equal to about 35% by weight and the mixture was mixed in a Hobart mixer at slow speed for about 90 minutes. The resulting very thick paste was then poured in a beaker half full with water. The paste sank to the bottom with slight dispersion of ash. The bulk paste hardened after three days. A similar sample was poured in a two-inch diameter by four-inch long ASTM standard cylinder. Water was poured on the surface and was also found set after three days. The strength of the cylinder was approximately 800 psi.

### EXAMPLE 5

### Ceramic Cement Using Solid Magnesium Hydroxide

Phosphate ceramics are formed by reacting dead burnt magnesium oxide and an acid phosphate. It is generally believed that it is not possible to produce magnesium phosphate ceramics using uncalcined magnesium oxide or hydroxide. As shown in Table 1, the water content in solid magnesium hydroxide is 33 wt. % and hence this material provides one of the best components for a fire retardant coating as the high amount of bound water can consume heat by evaporation. For this reason, magnesium hydroxide based coatings were tested. Thus, 180 grams of fine magnesium hydroxide powder were mixed with about 20 grams of mono potassium phosphate and about 1 gram of boric acid. To this dry mixture was added about 200 ml of water to produce a thin paste suitable for coating steels and other construction materials. Samples were mixed for about 10 minutes and poured into a two-inch-diameter-by-four-inch-tall mold. Some of it was also poured on a one-quarter-inch flat dish. The samples were cured. The flat dish sample dried and formed a well set ceramic. The tall cylindrical sample remained wet for one full day before hardening. Thus, Example 5 demonstrates that it is possible to produce a phosphate ceramic using uncalcined magnesium oxide and magnesium hydroxide suitable for coating steels and other construction materials and for providing improved flame retardancy properties thereto.

### EXAMPLE 6

### Methods of Forming Berlinite Coatings

Theoretical analysis based on thermodynamic principles indicate that aluminum trihydrogen phosphate, if reacted with aluminum oxide (corundum, Al₂O₃), would produce aluminum phosphate (AlPO₄) (berlinite) at about 150° C. Berlinite mineral phase, which is stable up to 1,500° C., would provide a high-temperature coating. Thus, 100 grams of aluminum trihydrogen phosphate (AlH₃(PO₄)₂.5H₂O) as a viscous paste was mixed with 50 grams of aluminum oxide fine powder and mixed thoroughly to form a thick paste. This was brushed on mild steel substrate pre-heated at 175° C. Initially, some water fraction from the paste evaporated, but the subsequent coating bonded well to the steel. The entire assembly was maintained at 175° C. for about three hours. Once all degassing and evaporation had occurred, a second coat was applied and cured for about three hours at 175° C. The resulting thick coating formed on the steel surface was hard, dense and extremely well bonded to the steel. X-ray diffraction studies of the formed coating prepared from Example 3 indicated that the coating was essentially berlinite. Thus, the methods disclosed and described herein provides for a relatively simple means for preparing berlinite-precursor formulations and thereafter forming berlinite coatings useful for providing high-temperature protection or improving high temperature service of articles, such as metals and other building materials.

1-51. (canceled)

52. A method of producing a high-temperature resistant coating, the method comprising:
providing a first component comprising at least one of phosphoric acid or aluminum trihydrogen phosphate AlH₃(PO₄)₂ or its hydrates;
providing a second component comprising at least one of aluminum hydroxide or aluminum oxide; combining the first component and the second component together; and
contacting a surface of an article with the combination of the first component and the second component; heating the surface of the article sufficient to form a coating consisting essentially of a berlinite phase (AlPO4) detectable by x-ray diffraction.

53. The method of claim 52, wherein the providing of the first component and the second component is by spray-coating.

54. The method of claim 52, wherein the surface is a structural element of a dwelling.

55. The method of claim 52, wherein the surface comprises steel beams, joists, wall boards, shingles, ceramic or tile flooring or counters, brick, stone.

56. The method of claim 52, wherein the surface comprises a kiln or furnace constructed at least in part with one or more refractory materials or a vertical take off or landing platform (VTOL).

57. The method of claim 52, wherein the surface comprises a power generator operating under a thermodynamic heat cycle.

58. An article prepared by the method of claim 52, comprising a coating thereon, the coating consisting essentially of a berlinite phase (AlPO₄) detectable by x-ray diffraction.
